(19) United States
(12) Patent Application Publication
(10) Pub. No.: US 2007/0024490 A1
(43) Pub. Date: Feb. 1, 2007

(54) Modification of Chart Representation of Tabular Data in an Information Display System

(75) Inventors: John Mervyn Carter, Chilworth (GB); Jeffrey Moreland, Eastleigh (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/422,634

(22) Filed: Jun. 7, 2006

(30) Foreign Application Priority Data
Jun. 10, 2005 (GB) 0511826.0

(51) Int. Cl. G01S 13/00; G06F 19/00; G06F 15/00

(52) U.S. Cl. 342/36; 702/19; 715/509

(57) ABSTRACT

A method and system for controlling the graphical display of stored user supplied tabular data as a chart in a system stores the data for display on a display device. In response to user selection of a style of representation, the tabular data is converted to a form corresponding to the selected style and displayed as a chart. Additionally, auxiliary data having a plurality of components each of which is associated with a respective component of the converted tabular data is produced and displayed as an auxiliary graphic concurrently with the chart on the display device. The auxiliary graphic is made interactive so that, in response to user selection and interactive manipulation of components of the auxiliary graphic by means of a pointing device, the conversion of the tabular data is controlled such that, when the chart is displayed, its components are modified in accordance with the interactive manipulation of the auxiliary graphic components.

### FIELD OF THE INVENTION

The present invention relates to the control of the display of tabular data in chart from and, in particular, to the modification of the displayed representation of the data.

### BACKGROUND OF THE INVENTION

One of the best known applications for the storage and manipulation of tabular data is the spreadsheet. Spreadsheets are commonly used for tabulating numerical data, such as financial data, against named resources, such as individuals or cost centres, or against intervals, such as time periods. The quantitative data may be totalled, subtotalled or otherwise mathematically manipulated in many ways. The arrangement of the data may also be rearranged to present it differently, for example, in a sales scenario, by person, by month or by commodity. These subsets of associated data are referred to as data series or data collections.

Associated with modern spreadsheet applications are so-called charting applications, which allow the written spreadsheet data to be converted into many different forms of visual display, to enable a more immediate appreciation of the data by a human user. Well know forms include bar or tower charts, pie charts and radar charts. The underlying conversion is effected automatically by the charting application in response to user selection of chart type. However, user input on the style attributes of the displayed chart is also needed. This includes simple matters like colour, shading, numerical ranges and whether and where actual numerical values should be displayed on the graphic components of the chart.

Another common feature of charting applications is the legend, which is a visual key linking the displayed graphic components with written descriptive information. A simple example would be a multi coloured pie or bar chart, in which the legend associates the colours with the names of the data sources, say salesmen or products. Legends may be displayed or not, as the user chooses and constitute passively displayed associated information to assist comprehension.

In more complex data situations, there may be a need for multiple subsets (data series) to be displayed on the same chart with the risk of data relating to one obscuring the others. An example might be a three dimensional tower chart, such as illustrated in FIG. 1. It can be seen that the towers in the front hide those behind. It is thus desirable to be able to rearrange or reorder the displayed information to optimise the amount of data visible.

This can be done by reorganising the data in the original spreadsheet tables to interchange rows or columns as required. However, this requires a considerable degree of user labour and is very inconvenient and liable to introduce errors.

An approach to solving this problem for at least some type of charts is available as part of the well known Excel spreadsheet product from Microsoft Corporation (“Excel” is a trademart of Microsoft Corporation). This is described in the Microsoft Office Training course “Charts III: Create a professional looking chart”. This course can be found on the internet at http://office.microsoft.com/training/. In one subsection, entitled “Change the order of data on the chart”, the complex tower chart problem is illustrated, showing and comparing the number of US and UK sales by year. The UK towers partially obscure the US ones and the course describes how to change the order so that the US ones are displayed at the front. No user editing of the original data tables (“worksheets” in the language of the Microsoft product) is necessary. However, it is necessary for the user to go through several steps involving exiting from the chart display screen. First a Data Series tab is selected and a new screen appears. Then an option to “Format Data Series” is displayed. Clicking a “Series Order” tab produces a “Series Order” box. In this box, the user must select “U3” and click a “Move Up” button to reverse the order of display in the tower chart.

Although this does the job, it does require the user to go through several operations and to exit from the basic display chart in which he is interested. Also, this method of reordering the chart is only described for tower charts. It would be desirable to be able to reorder charts more generally, directly from the chart display screen.

Other types of user manipulation of charts than reordering are also known. In an article entitled “Custom Radar Chart” from Tushar Mehta Consulting (available on the Internet at http://www,tushar-mehta.com/excel/soft/sof tware/custom radar/), the normalising of axes of a radar chart, created in Excel is taught. Instead of each axis having its own minimum and maximum range of values, the values are constrained to lie within a range of 0 to 1. This modifies the visual appearance of the chart to the user considerably. How this is achieved is not described except that it is by means of software in development and does not include a user interface.

A product from ILOG, Inc. “ILOG JViews Charts” (available on the Internet at http://www.iloa.com/products/iviews/demos/) offers a wide range of chart types and enables users to alter default settings by selecting custom parameters such as types of scale, manipulation of axes, location of labels and legends. Customization of look-and-feel is achieved without coding using a point-and-click editor, complete with wizards. The user interaction may be with associated graphic controls, located in panels displayed alongside the main window displaying the chart of interest. In at least one example of a pie chart, selection of a label located on and identifying the content of a respective segment of the pie chart causes the display of a further smaller pie chart on top of the original chart. The secondary pie chart displays further segmented detail of the content of the original selected segment. Thus, the ILOG product offers attribute selection, including a further level of detail, by selection of a concurrently displayed graphic symbol.

However, none of the above referenced art offers general interactive manipulation of a range of chart types directly from the chart screen. Such a facility would greatly improve usability.

### DISCLOSURE OF THE INVENTION

Accordingly, the present invention provides an information display control system for displaying tabular data graphically as a chart, the system comprising: means for storing tabular data, input by a user; means for permitting user selection of a style of representation of the tabular data in a chart; charting means for converting the tabular data to a form corresponding to the user selected style of representation suitable for input to and display by a display device; means for additionally producing auxiliary data having a plurality of components each of which is associated with a respective component of the converted tabular data, the auxiliary data also being suitable for input to and display as an auxiliary graphic by the display device concurrently with display of the tabular data; and control means responsive to user selection and interactive manipulation of components of the auxiliary graphic to control the conversion of the tabular data such that, when displayed, its components are modified in accordance with the interactive manipulation of the auxiliary graphic components.

According to a second aspect, the invention provides a method for controlling the graphical display of stored user supplied tabular data as a chart in a system comprising a memory store for the tabular data, a display device and an interactive pointing device for a user, the method comprising the steps of: in response to user selection of a style of representation, converting the tabular data to a form corresponding to the selected style; displaying the converted tabular data as a chart in the selected style; additionally producing auxiliary data having a plurality of components each of which is associated with a respective component of the converted tabular data; chart on the display device; and in response to user selection and interactive manipulation of components of the auxiliary graphic by means of the pointing device, controlling the conversion of the tabular data such that, when displayed, its components are modified in accordance with the interactive manipulation of the auxiliary graphic components.

Thus, by mapping the components of the converted tabular data to components of a concurrently displayed auxiliary graphic and enabling interactive manipulation of the auxiliary graphic components, the appearance of the displayed converted data can be changed very generally to emphasise various aspects thereof. These aspects include the order of display of multiple subsets of the data and the relative weighting or scaling of individual components.

Preferably, the control means controls the conversion of the tabular data by transforming the tabular data prior to its input to the charting means. It would, in theory, be possible for the transformation to be applied to data for output to the display by the charting means but this would require far more complex intervention at the level of generation of drawing orders for a drawing engine.

The invention is useful where the order of the auxiliary graphic components may be manipulated so that the charting means is effective to display the converted tabular data components in an ordered arrangement, mirroring the order of their associated auxiliary graphic components. This may be applied, for example, to the order and position of axes in a radar chart. However, it is also useful where the tabular data components are grouped in a plurality of subsets and the auxiliary graphic has components corresponding to respective subsets, interactive manipulation of the order of which causes the modification of the order of the displayed subsets in accordance with user manipulation of the order of their associated auxiliary graphic components. This can be applied, for example, to tower charts having multiple sets of towers in order to change which set appears at the front.

The auxiliary graphic may be conveniently manipulated by dragging and dropping the keyed legend components to rearrange them although other techniques, such as shift key icons, could be employed.

Conveniently, though not essential to the invention, the auxiliary graphic may also be a conventional legend identifying components of the displayed chart by means of colour or equivalent shading.

Other interactive graphic techniques for controlling other aspects of different types of chart, such as radar charts, include sliders, for altering the weighting of axes differentially rather than merely normalising them.

### BRIEF DESCRIPTION OF THE DRAWINGS

The present invention will now be described, by way of example only, with reference to a preferred embodiment thereof, as illustrated in the accompanying drawings, in which:

FIG. 1 is an example of a known type of tower chart to which the present invention can be applied;

FIG. 2 shows the tower chart of FIG. 1 reordered by a method and system according to the invention;

FIG. 3, is a flow diagram illustrating a method for controlling the graphic display of stored user supplied tabular data as a chart according to the invention;

FIG. 4 is a combined system and sequence diagram of an information display control system for displaying tabular data as a chart according to the invention;

FIG. 5 shows a typical normalised radar chart and an auxiliary graphic for modifying the display of the chart according to the present invention;

FIG. 6 shows the chart and auxiliary graphic of FIG. 5 after modification of the cyclic order of the chart axes;

FIG. 7 shows the chart and auxiliary graphics of FIG. 6 after modification of the differential weighting applied to different axes; and

FIG. 8 is a flow diagram illustrating the method of modifying the auxiliary graphic and radar chart as shown in FIGS. 5 to 7.

### DETAILED DESCRIPTION OF THE INVENTION

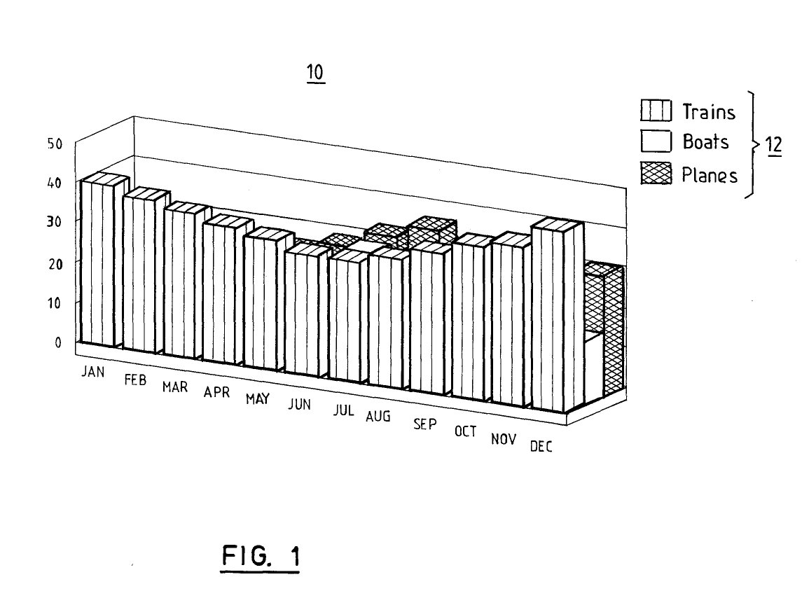

The invention is most easily described in connection with an example of a chart, as shown in FIG. 1. As already described in connection with the prior art, FIG. 1 shows a tower chart 10 illustrating the monthly variation over a one year period in sales of model trains, boats and planes. The chart is created by a charting application from a data table such as a spreadsheet. The data forming the spreadsheet is entered raw by the user, though it may be further manipulated by the spreadsheet program in accordance with user selected mathematical operations. The table which is the data source for the chart of FIG. 1 is as follows:

| | Trains | Boats | Planes |
|---|---|---|---|
| January | 40 | 10 | 15 |
| February | 38 | 12 | 17 |
| March | 36 | 14 | 19 |
| April | 34 | 17 | 22 |
| May | 32 | 20 | 25 |
| June | 30 | 25 | 28 |
| July | 30 | 30 | 32 |
| August | 32 | 30 | 35 |
| September | 35 | 25 | 30 |
| October | 38 | 20 | 30 |
| November | 40 | 17 | 25 |
| December | 45 | 15 | 30 |

The charting application is generally part of a commercial spreadsheet program, such as the Microsoft Excel or ILOG JViews programs mentioned in connection with the prior art. A variety of chart types are offered for the user to select such as bar, tower, pie and radar charts. The user is also able to select attributes of the displayed chart, such as colour, shading and alphanumerical labelling of axes or actual objects.

Another user selectable or automatically created attribute is an auxiliary graphic known as a legend block 12. Conventionally, this maps collections of data, which are subsets of the whole, to descriptive information. Thus, in the chart of FIG. 1, the towers in the front row are the Trains, those in the middle row are the Boats and those in the back row are the Planes. Such legends, in the prior art, were passive objects.

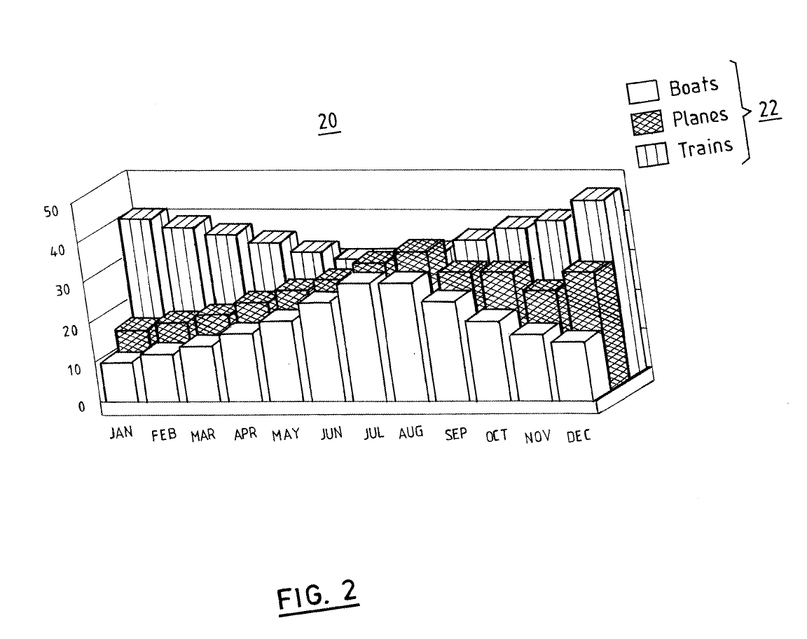

As explained in the introduction, the user may wish to alter the way in which the data is presented more extensively than by merely changing the type of chart, its colouring, or its descriptive text. For example, in the tower chart case, it may be desirable to alter the order of drawing of the three data collections so that the Boats towers are not obscured by the Trains towers, producing a new chart as shown in FIG. 2. Clearly, this could be achieved by recreating or editing the original data table. It can also be achieved in the case of a tower chart, as described above in connection with the Microsoft Excel product, by exiting from the displayed chart screen and following a sequence of operations to reorder the data series. The latter approach does not require revision of the data table by the user but does involved multiple steps.

The present invention enables the chart of FIG. 1 to be rearranged into the differently ordered chart of FIG. 2 by the expedient of making the legend interactive, rather than passive. The user clicks on the legend components 12, using a conventional pointing device such as a mouse, and uses a conventional drag and drop operation to alter the order of the legend components to that shown at 22 in FIG. 2. In the new order, the components are rearranged so that Boats is the topmost legend component, with Planes and then Trains underneath. In response to this manipulation of the legend, the displayed towers are also rearranged as shown in chart 20, FIG. 2, to bring the Boats towers to the front of the chart, with Planes in the middle and Trains moved to the back. Of course, in the general case of more than three data collections, multiple drag and drop operations may be needed to achieve the desired reordering.

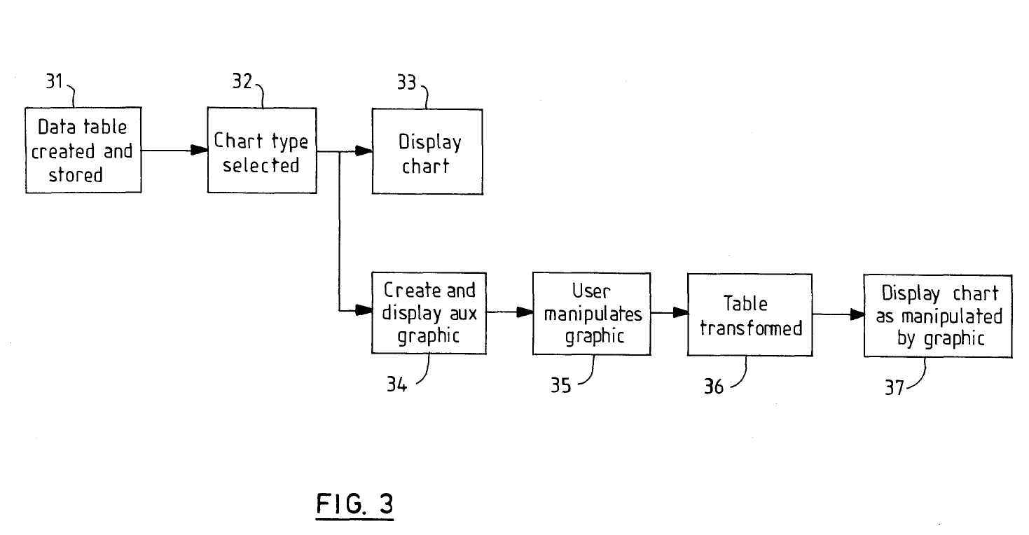

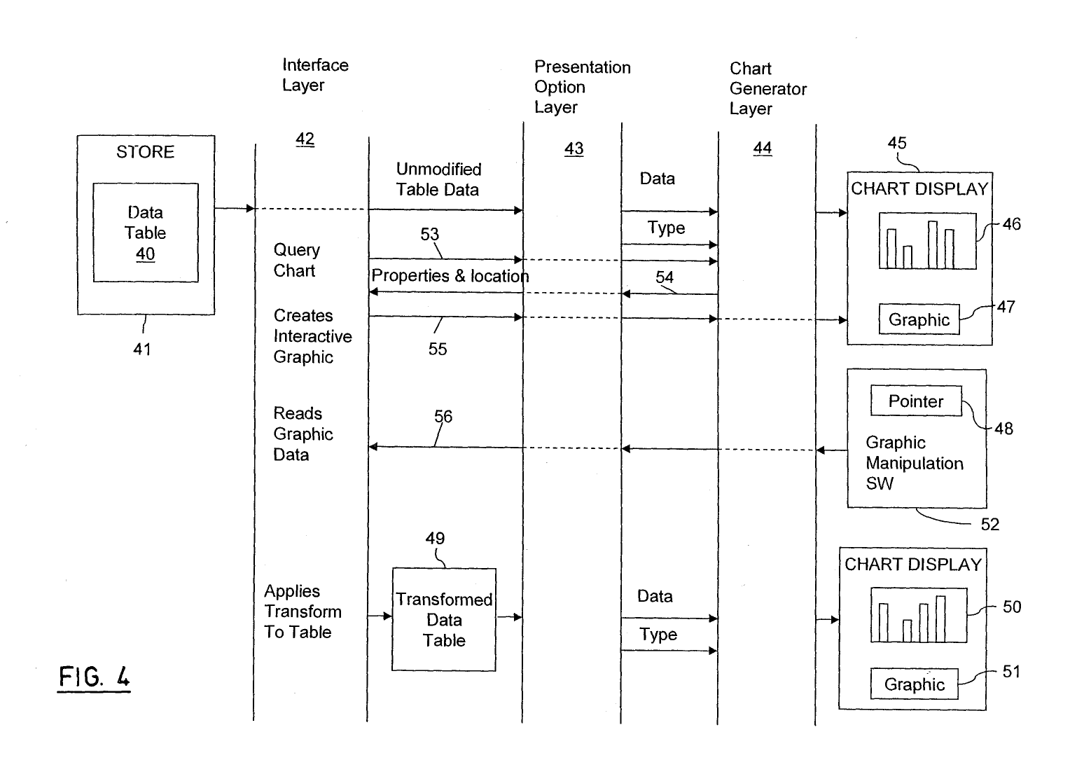

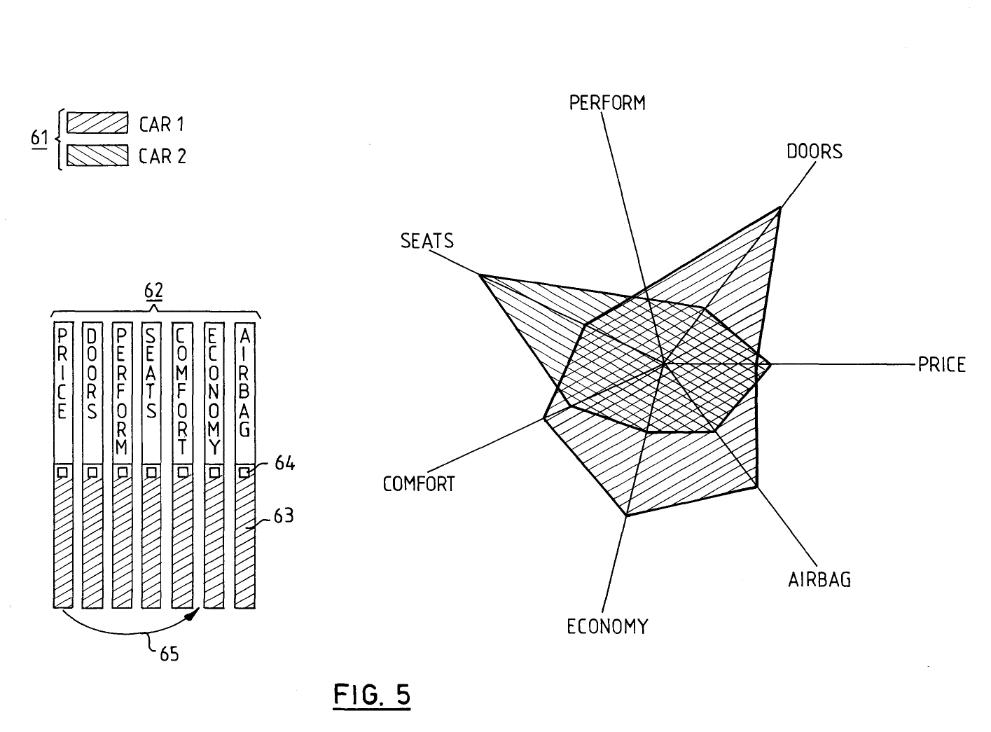

Such a reordering is achieved by means of the method for controlling the graphical display of stored user supplied tabular data as a chart according to the invention, shown in the flow diagram of FIG. 3. An example of an information display control system according to the invention for carrying out the method and of the sequence of the operation is shown in FIG. 4. These examples are general in that they are not limited to the tower chart example of FIGS. 1 and 2 but also apply to a radar chart example to be described below in connection with FIGS. 5 to 7.

With reference to FIGS. 3 and 4 a spreadsheet data table 40 (FIG. 4) is created by the user and stored, in step 31 (FIG. 3) in a computer memory store 41 (FIG. 4). The data from the table 40 passes unmodified through an interface layer 42, which is the first software component of an information display control system according to the invention, and is applied to a presentation option layer 43, which is the second software component of the system. In step 32, the user selects the desired chart type from options presented by layer 43. The table data and user chart type selection are then applied to a third software component, namely, a chart generator layer 44. In step 33, the chart generator layer 44 renders the table data into an appropriate input signal for a display device 45 (FIG. 4) which then displays the information in the selected style as a chart 46. The presentation option layer 43 and chart generator layer 44 together constitute a charting application such as is provided as part of one of the commercially available programs already mentioned.

The interface layer 42 is responsible for generating, in step 34 (FIG. 3), an interactive auxiliary graphic 47 which is displayed concurrently with chart 46. It does this by first querying the chart generator layer on line 53 to determine the properties and location available for the auxiliary graphic 47. Such a query facility requires relatively trivial modification to the charting application.

In the case of FIGS. 1 and 2, the auxiliary graphic 47 will be the legend 12 which looks identical to the passive version which would normally be created by the charting application in response to a user selection in layer 43 of an option to display a legend. Data from the charting application, including the chart type, legend location and attributes such as colours of the passive legend are fed back to the interface layer to enable it to create an identical looking legend. The interface layer software suppresses the generation of the passive version of legend and replaces it, in step 34 (FIG. 3), with the identical looking interactive legend 12 of FIG. 1, equivalent to the auxiliary graphic 47 of FIG. 4. Because they are identical, in both cases, components of the legend are still associated with respective components of the chart as displayed.

If, on the other hand, a completely new auxiliary graphic is required, as will be described in connection with the radar charts of FIGS. 5 to 7 below, only the chart type and available location for the auxiliary graphic need be fed back to the interface layer 42. This feedback is generally indicated as “Properties & location” on the line 54 in FIG. 4. Receipt of the fed back data on line 54 causes the interface layer 42, in step 34, to create the interactive auxiliary graphic data. The auxiliary graphic data is input to the display device on line 55 and displayed as auxiliary graphic 47 concurrently with the chart 46.

An alternative solution for the generation of the auxiliary graphic, which may be more easily implemented, particularly for the radar chart where a completely new auxiliary graphic is required, is for the interface layer to generate the auxiliary graphic in a new window, without reference to the charting application. The user could then position the new window over the window containing the chart, in the most convenient location. With this alternative, the query on line 53 and feedback of properties and location on line 54 would not be necessary although the interface layer would still pick up the data and type of chart selected from the user selection in step 32 to determine the appropriate form of auxiliary graphic for the extra window.

However, generated, unlike the passive legend of the prior art, the auxiliary graphic 47 has been made interactive in that it can be selected and manipulated by a user into a rearranged form 51. This is done in step 35 by means of a conventional pointing device 48, such as a mouse, touch pad or keyboard and associated graphic manipulation software 52. If the user has changed the graphic by moving or altering the components, the modified graphic data is read on line 56 by the interface layer software 42 and used as a control to transform the tabular data 40, in step 36 (FIG. 3), into a transformed data table 49. This data again passes through the presentation option software layer 43 and, as the original chart type remains selected, is redisplayed, in step 37 (FIG. 3), as modified chart 50 and modified graphic 51. In practice, the redisplay of modified chart 50 does not take place until manipulation of the auxiliary graphic is completed.

Although FIG. 4 shows separate interface layer software for generating the interactive auxiliary graphic 47, it would be possible for the charting application to be modified to perform this function. This alternative is not described.

In FIGS. 5, 6 and 7, an example of the application of the invention to a radar chart is described. FIG. 5 is a radar chart, which, in this example, is used to illustrate comparatively the various attributes of two cars, Car 1 and Car 2. The displayed chart 61 in FIG. 5 is assumed to be what would be produced by a commercial charting package from an applied input data table prior to any manipulation. The attributes considered are performance, number of seats, comfort, economy, number of airbags, price and number of doors, each represented by a respective radial axis. The units of measurement of each axis may be arbitrary or the scale to which they are displayed may be normalised to a range 0 to1, where 1 represents the maximum possible value of each attribute. The apex of each property for each of the manufacturers and, to some extent the size of the visually distinct area terminating in the apex gives a ready visual means of comparison. Two auxiliary graphics are also shown. A first graphic 61 is a conventional legend, like that in FIGS. 1 and 2, and simply identifies each car by appropriate hatching. It will be realised that, in a real application, shading or colour will most likely be used to visually distinguish the two cars, rather than the hatching used in these drawings.

In this particular chart, little additional information can be gained by making this legend interactive as the apexes of the various properties remain visible irrespective of which car's chart components are drawn on top. However, note that if the visual marking, for example, colour, were opaque, so that the topmost car's chart components partly obscured the underlying car's chart components, it would be possible to make graphic 61 interactive and change the vertical ordering of the two car's display components in the same manner as in the tower charts of FIGS. 1 and 2.

However, to better assist a human user in making comparisons of the two cars, it would be desirable to be able to change the cyclic order of the axes so that, different comparisons of the two cars can be made. For example, it would be more desirable to have the Price and Economy axes adjacent as these are closely related quantities. Another desirable change would be to be able to alter the scaling of the axes to emphasise some aspects rather than others by overriding the initial display values scales. This would enable aspects considered of primary importance by a particular buyer to be given increased weight and unimportant aspects to be reduced or minimised.

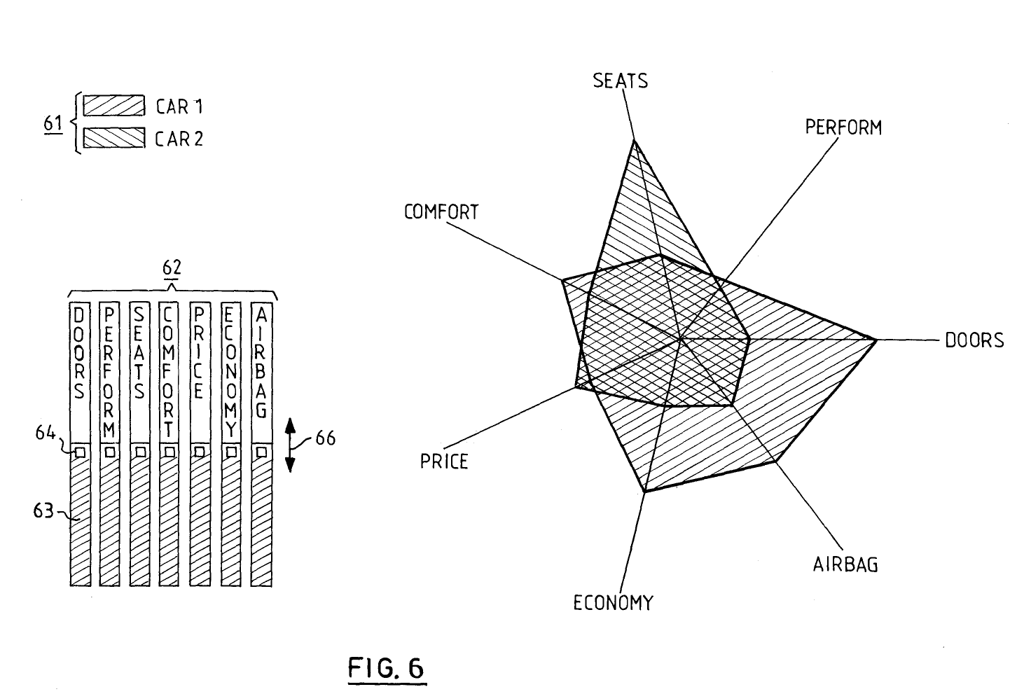

Although all these aspects can be changed by altering the input data table and rerunning the charting application, in the present example this is effected, in accordance with the present invention, by means of a further auxiliary graphic 62 which is interactive. Each of the axes of the chart is represented by a correspondingly named bar 63. To change the order of the chart axes, the lateral order of bars 63 is changed by means of drag and drop operations on the bars to be moved, as indicated by the arrow 65 in FIG. 5. This produces a reordered radar chart as illustrated in FIG. 6 in which the Price axis has been moved adjacent to the Economy axis.

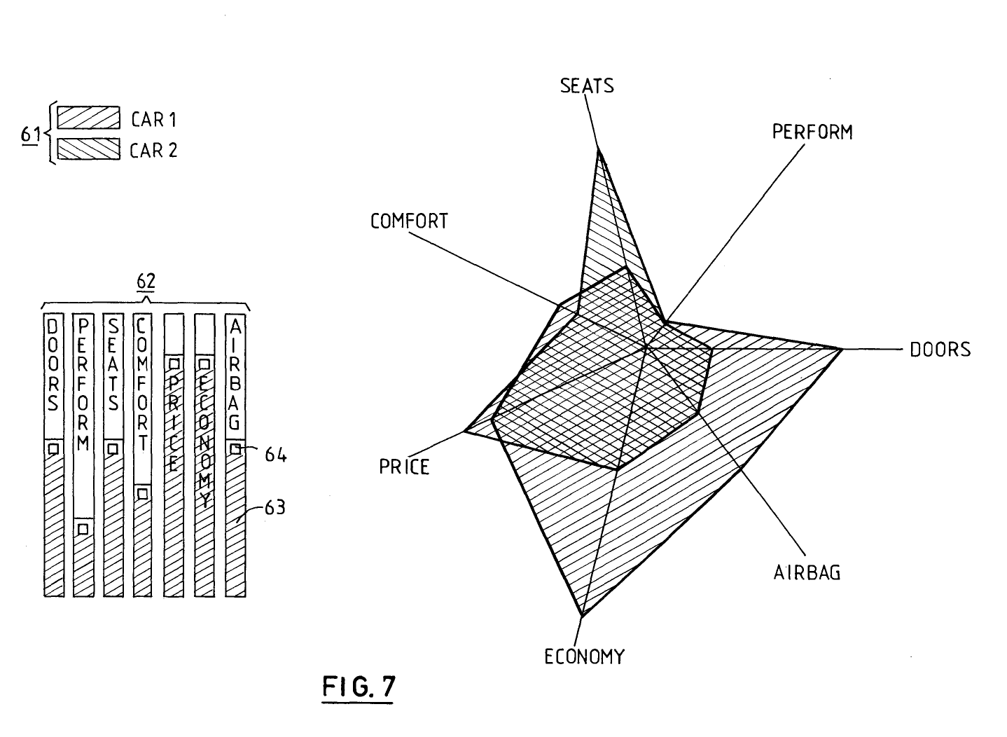

The fill level of bars 63 is indicated by hatching and can be altered by means of thumb pad slider controls 64 which may be moved up or down individually as indicated by the arrow 66 in FIG. 6. In FIGS. 5 and 6, the fill levels are initialised at the 50% level corresponding to the initially selected or normalised attribute display value ranges. FIG. 7, however, shows the effect of different fill levels on the chart display. In the example chosen, price and economy are emphasised whereas performance and comfort are de-emphasised.

Even more complex changes, such as differentially altering the angles between axes could be made if desired, for example by making the bars 63 relatively movable laterally, for example by providing them with associated right and left shift arrows 9 not shown). Subgroups of axes could also be linked so that scaling changes to any axis would apply to all its linked axes.

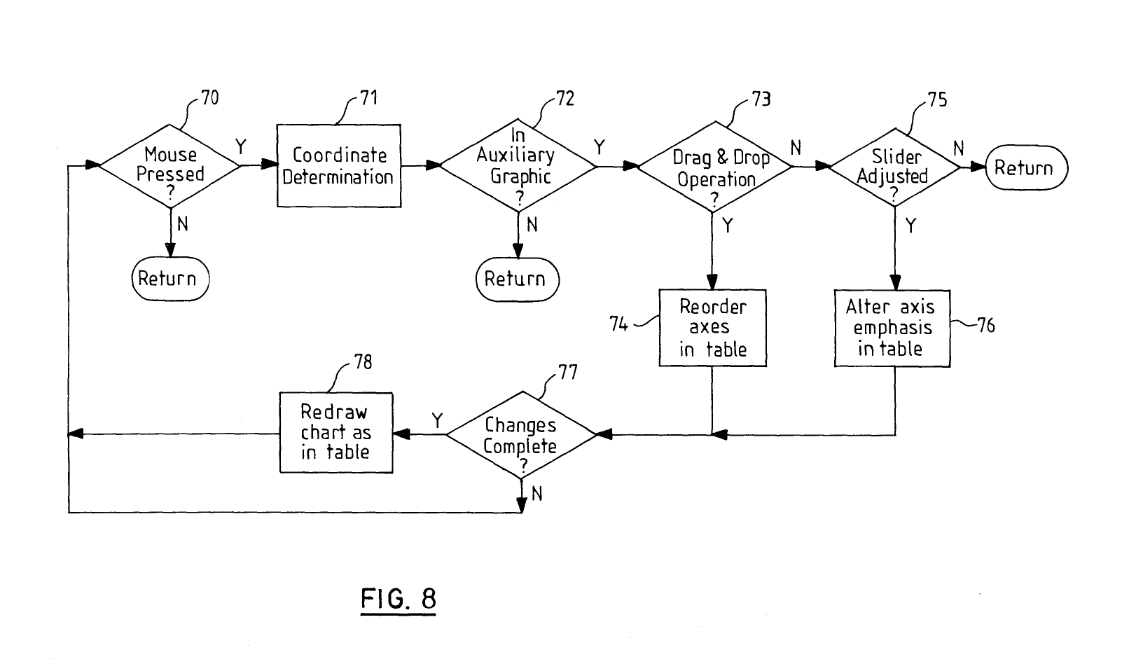

The method and system of control of the radar chart of FIGS. 5 to 7 follows exactly the generic method and system of FIGS. 3 and 4. However, the preferred method of detecting changes to the auxiliary graphic for the radar chart example will now be described with reference to FIG. 8.

FIG. 8 is a flow diagram showing an implementation of graphic manipulation software 52 (FIG. 4) for the manipulation of graphic 62 associated with the radar chart example of FIGS. 5 to 7. The process starts with detection of pointer device 48 activation, specifically of a mouse button being pressed, in step 70. There follows a coordinate determination step 71 after which it is determined in step 72 whether the mouse pointer is in the box containing the auxiliary graphic 62. If not, control returns to the charting application.

Step 73 is a conventional drag and drop operation to reorder the bars 63. In step 74, a reordering of bars 63 causes a transformed data table 49 to be generated to reflect the new order of the radar chart axes. Step 75 corresponds to an adjustment of the slider positions of one or more bars 63 and, in step 76, data in table 49 is further transformed to alter the emphasis (weighting) of respective attributes of the two cars.

If all changes to the auxiliary graphic 62 are determined to have been completed in step 77, then the transformed data table is reapplied to the charting application to redraw the modified chart in step 78. A determination of whether the changes are complete can be explicitly requested from the user or inferred from the mouse being released and the cursor moving off the graphic 62.

1. An information display control system for displaying tabular data graphically as a chart, the system comprising:
means for storing tabular data, input by a user;
means for permitting user selection of a style of representation of the tabular data in a chart;
charting means for converting the tabular data to a form corresponding to the user selected style of representation, suitable for input to and display by a display device;
means for producing auxiliary data having a plurality of components each of which is associated with a respective component of the converted tabular data, the auxiliary data also being suitable for input to and display as an auxiliary graphic by the display device concurrently with display of the tabular data; and
control means responsive to user selection and interactive manipulation of components of the auxiliary graphic to control the conversion of the tabular data such that, when displayed, its components are modified in accordance with the interactive manipulation of the auxiliary graphic components.

2. A system as claimed in claim 1 in which the control means controls the conversion of the tabular data by transforming the tabular data prior to its input to the charting means.

3. A system as claimed in claim 1 in which the order of the auxiliary graphic components may be manipulated so that the charting means is effective to display the converted tabular data components in an ordered arrangement, mirroring the order of their associated auxiliary graphic components.

4. A system as claimed in claim 3 in which the tabular data components are grouped in a plurality of subsets, the auxiliary graphic having components corresponding to respective subsets, interactive manipulation of the order of which causes the control means to modify the order of the displayed subsets in accordance with user manipulation of the order of their associated auxiliary graphic components.

5. A system as claimed in claim 4 in which the auxiliary graphic is a legend, whose components map to and identify corresponding subsets of the displayed representation of the tabular data.

6. A system as claimed in claim 4 in which the displayed representation of the tabular data is a three dimensional tower chart having a plurality of subsets of towers in an ordered arrangement, one in front of another.

7. A system as claimed in claim 3 in which the means for modifying the displayed representation is responsive to a change of order of the auxiliary graphic components resulting from a user drag and drop operation on a selected component.

8. A system as claimed in claim 3 in which the displayed representation of the tabular data is a radar chart, the ordered arrangement being the angular order of the axes of the components about the origin.

9. A system as claimed in claim 1 in which each auxiliary graphic component includes a weighting indication, suitable for manipulation, the charting means being effective to display the converted tabular data components in a weighted arrangement, mirroring the weighting indication of their associated auxiliary graphic components.

10. A system as claimed in claim 9 in which each auxiliary graphic weighting indication is manipulated by means of an associated slider and the control means is responsive to the user selected position of the slider to weight the corresponding component representation accordingly.

11. A system as claimed in claim 10 in which the chart is a radar chart and the weighting represented by each slider is applied to a corresponding radar chart axis.

12. A method for controlling the graphical display of stored user supplied tabular data as a chart in a system comprising a memory store for the tabular data, a display device and an interactive pointing device for a user, the method comprising the steps of:
in response to user selection of a style of representation, converting the tabular data to a form corresponding to the selected style;
displaying the converted tabular data as a chart in the selected style;
additionally producing auxiliary data having a plurality of components each of which is associated with a respective component of the converted tabular data;
displaying the auxiliary data as an auxiliary graphic concurrently with the chart on the display device, and
in response to user selection and interactive manipulation of components of the auxiliary graphic by means of the pointing device, controlling the conversion of the tabular data such that, when displayed, its components are modified in accordance with the interactive manipulation of the auxiliary graphic components.

13. A method as claimed in claim 12 in which the order of the auxiliary graphic components may be manipulated so that the modifying step modifies the displayed representation of the tabular data components to display them in an ordered arrangement mirroring the order of the auxiliary graphic components.

14. A method as claimed in claim 13 in which the tabular data components are grouped in a plurality of subsets, the auxiliary graphic having components corresponding to respective subsets, the step of modifying the displayed representation of the tabular data modifying the display of subsets in accordance with user selection and manipulation of the order of their associated auxiliary graphic components.

15. A method as claimed in claim 14 in which the auxiliary graphic is a legend, whose components map to and identify corresponding components of the displayed representation of the tabular data.

16. A method as claimed in claim 14 in which the displayed representation of the tabular data is a three dimensional tower chart having a plurality of subsets of towers in an ordered arrangement, one in front of another.

17. A method as claimed in claim 13 in which the step of modifying the displayed representation is responsive to a change of order of the auxiliary graphic components resulting from a user drag and drop operation on a selected component.

18. A method as claimed in claim 13 in which the displayed representation of the tabular data is a radar chart, the ordered arrangement being the angular order of the axes of the components about the origin.

19. A method as claimed in claim 12 in which each auxiliary graphic component includes a weighting indication, suitable for manipulation, the step of modifying the displayed representation being effective to display the converted tabular data components in a weighted arrangement, mirroring the weighting indication of their associated auxiliary graphic components.

20. A method as claimed in claim 19 in which each auxiliary graphic weighting indication is manipulatable by means of an associated slider and the step of modifying the corresponding displayed component is responsive to the user selected position of the slider to weight the corresponding component representation accordingly.

21. A method as claimed in claim 20 in which the chart is a radar chart and the weighting represented by each slider is applied to a corresponding radar chart axis.

22. A computer program for controlling the graphical display of stored user supplied tabular data, the program comprising instruction which, when executed on a computer, causes the performance of a method as claimed in claim 12.
